(19) United States
(12) Patent Application Publication
(10) Pub. No.: US 2024/0238851 A1
(43) Pub. Date: Jul. 18, 2024

(54) Plasma cleaning head and plasma cleaning equipment for optical parts

(71) Applicant: Harbin Institute of Technology, Harbin (CN)

(72) Inventors: Peng ZHANG, Harbin (CN); Lihua LU, Harbin (CN); Qiang GAO, Harbin (CN); Yuheng GUAN, Harbin (CN); Hang ZHAO, Harbin (CN); Yongzhi CAO, Harbin (CN); Jiaxuan CHEN, Harbin (CN)

(21) Appl. No.: 18/505,084

(22) Filed: Nov. 8, 2023

(30) Foreign Application Priority Data
Nov. 8, 2022 (CN) 202211389504.8

(51) Int. Cl. B08B 7/00; B08B 5/00; G02B 27/00; H05H 1/46

(52) U.S. Cl. CPC B08B 7/00; B08B 5/00; G02B 27/0006; H05H 1/4645; B08B 2240/00; H05H 2245/40

(57) ABSTRACT

The present disclosure relates to the technical field of plasma cleaning, and provides a plasma cleaning head for an optical member and a plasma cleaning device, including a plasma circulation assembly having a hollow shape and a lens frame mounted on the plasma circulation assembly, wherein the plasma circulation assembly is provided with an outlet port which is larger than an ejection port adapted to eject a plasma and is adapted to diffuse the plasma, and the lens frame is in communication with and surrounds the outlet port, and the lens frame is adapted to embed an optical lens body so that the optical lens body is arranged opposite to the outlet port to help improve dispersion and stability of the plasma flowing from the outlet port to the optical lens body, and helps to promote the energy absorption of the plasma by the optical lens body.

### CROSS-REFERENCE TO RELATED APPLICATION

This application claims priority from the Chinese patent application 202211389504.8 filed Nov. 8, 2022, the content of which is incorporated herein in the entirety by reference.

### TECHNICAL FIELD

The present disclosure relates to the technical field of plasma cleaning, and more particularly, to a plasma cleaning head for an optical member and a plasma cleaning device.

### BACKGROUND ART

In the related art, an existing plasma cleaning device generally comprises a plasma spray head, wherein a spray port on the plasma spray head is arranged opposite to an optical member, and the plasma sprayed from the spray port is suitable for cleaning the optical member. However, the gas flow velocity of the plasma outside the spray port tends to sharply decrease, which tends to hinder the optical member from absorbing energy from the plasma, thereby restricting the performance of the plasma cleaning the optical member.

### SUMMARY

The present disclosure provides a plasma cleaning head for an optical member and a plasma cleaning device in response to a problem in the prior art that an ejection port adapted to eject a plasma may restrict the performance of the plasma cleaning the optical member.

According to an aspect of the present disclosure, there is provided a plasma cleaning head for an optical member, wherein the plasma cleaning head for an optical member comprises a plasma circulation assembly having a hollow shape and a lens frame mounted on the plasma circulation assembly;
the plasma circulation assembly is provided with an outlet port which is larger than an ejection port adapted to eject a plasma and is adapted to diffuse the plasma; and
the lens frame is in communication with and surrounds the outlet port, and the lens frame is adapted to embed an optical lens body so that the optical lens body is arranged opposite to the outlet port.

The beneficial effects of the above-mentioned technical solution are that, on the one hand, compared with providing an ejection port adapted to eject a plasma, the outlet port has the performance of expanding an outflow area of the plasma and dispersing the outflow plasma, promoting the plasma to homogenize the gas flow velocity inside and outside the plasma circulation assembly, helping to alleviate the sharp drop of the gas flow velocity of the plasma outside the plasma circulation assembly; on the other hand, the lens frame has the performance of solidifying the spatial orientation of the plasma circulation assembly and the optical lens body, preventing the plasma exiting the outlet port from being obstructed, and defining a space where the plasma flows from the outlet port to the optical lens body, promoting the outlet port and the optical lens body to be in a relatively static state so as to prevent the outlet port and the optical lens body from being in a relatively running state, not only improving a utilization rate of the lens frame, but also improving a stability between the outlet port and the optical lens body, helping to improve dispersion and stability of the plasma flowing from the outlet port to the optical lens body, thereby helping to promote the optical lens body to absorb energy from the plasma, helping to improve strength and efficiency of the plasma for cleaning the optical lens body over a large area, and freeing from a dilemma of the spray port restricting the performance of the plasma cleaning an optical member.

On the basis of the above-mentioned technical solution, the present disclosure also makes the following improvements to the plasma cleaning head for an optical member.

Optionally, the plasma circulation assembly comprises a first fixed frame and a dielectric barrier-free electrode subassembly embedded in the first fixed frame;
the first fixed frame is provided with the outlet port, and the outlet port is located at one side of the dielectric barrier-free electrode subassembly; and
the lens frame is detachably butted to the first fixed frame, a lens surface to be cleaned is provided on the optical lens body, and the lens surface to be cleaned is arranged parallel to and opposite to a plane where the outlet port is located.

The beneficial effects of the above-mentioned technical solution are that, by means of the first fixed frame, the dielectric barrier-free electrode subassembly is urged to perform space avoidance on the outlet port; compared to the outlet port being distributed directly in front of the dielectric barrier-free electrode subassembly, it is facilitated to uniformly distribute the plasma in the first fixed frame, and is facilitated to uniformly distribute the outflow plasma at the outlet port; and the lens frame is urged to be detachably mounted on the plasma circulation assembly, so as to facilitate the disassembly and assembly of the lens frame and the plasma circulation assembly.

Compared with the lens surface to be cleaned covering the outlet port, the lens surface to be cleaned is spaced from the outlet port, extending the space from the outlet port to the lens surface to be cleaned, facilitating the dispersed flow of plasma in the space from the outlet port to the lens surface to be cleaned, and facilitating more uniform cleaning of lens surface to be cleaned by plasma.

Optionally, a first groove is further provided on the first fixed frame, a notch of the first groove is provided as a first notch communicating with the outlet port, the first notch is distributed inside the first fixed frame, and the dielectric barrier-free electrode subassembly is detachably mounted in the first groove.

The beneficial effects of the above-mentioned technical solution are that, by means of the first groove, the dielectric barrier-free electrode subassembly is facilitated to be detachably accommodated inside the first fixed frame, which not only improves the space utilization rate inside the first fixed frame, but also facilitates the disassembly and assembly of the first fixed frame and the dielectric barrier-free electrode subassembly, so as to facilitate the maintenance of the plasma circulation assembly.

Optionally, a plurality of sets of the dielectric barrier-free electrode subassemblies are uniformly arranged in the first groove.

The beneficial effects of the above-mentioned technical solution are that a space is uniformly distributed among the plurality of sets of dielectric barrier-free electrode subassemblies in the first groove, increasing the space utilization rate of the first groove and facilitating uniform electric field.

Optionally, a bottom of the first groove is provided as a first groove bottom, and the dielectric barrier-free electrode subassembly comprises an insulating groove body, a yield screw, a conductive clamping seat, a first electrode plate, a conductive connecting cylinder, a second electrode plate and an insulating nail;
a second groove is provided on the insulating groove body, a notch of the second groove is provided as a second notch, and a bottom of the second groove is provided as a second groove bottom;
the insulating groove body is embedded in the first groove, and a plane where the second notch is located coincides with a plane where the first notch is located;
the yield screw is inserted in the insulating groove body, and a screw tail of the yield screw is in threaded connection with the first groove bottom;
the conductive clamping seat, the first electrode plate, the conductive connecting cylinder, the second electrode plate and the insulating nail are all arranged in the second groove;
the conductive clamping seat is embedded in the second groove bottom and the first electrode plate, the first electrode plate and the second electrode plate are oppositely arranged and form an electrode space;
the conductive connecting cylinder is arranged in the electrode space, and two ends of the conductive connecting cylinder respectively abut against the first electrode plate and the second electrode plate; and
the insulating nail is successively inserted in the first electrode plate, the conductive connecting cylinder and the second electrode plate, and a nail tail of the insulating nail is embedded in the second groove bottom.
The beneficial effects of the above-mentioned technical solution are that, compared with the case where the notch of the insulating groove body is exposed outside the first groove, the insulating groove body is better fitted into the first groove, so as to prevent the first groove from being too large and facilitate narrowing or thinning of the plasma circulation assembly.

With the aid of the yield screw, the insulating groove body is urged to be fixed inside the first groove in a detachable manner, and the insulating groove body has the properties of both covering the yield screw and spatially isolating the yield screw from the second groove, so as to urge the yield screw to avoid the second groove in the insulating groove body, so as to prevent the yield screw from completely exposing the first groove and generating structural interference to the second groove, thereby improving the utilization rate of the insulating groove body.

In the second groove, the conductive clamping seat has both the performances of fixedly connecting and electrically connecting the first electrode plate; by means of a layered electrode structure formed by the first electrode plate and the second electrode plate together, the conductive connecting cylinder is stable in the electrode space, and the conductive connecting cylinder has the performances of electrically connecting the first electrode plate and the second electrode plate; the conductive clamping seat is promoted to be stably connected to the second electrode plate via the first electrode plate and the conductive connecting cylinder in sequence in a dual-purpose manner, so as to improve the utilization rate of the conductive clamping seat, the first electrode plate, the conductive connecting cylinder and the second electrode plate, improve the stability of the electrode space and the space utilization rate of the second groove, and expand an electrode area which helps to increase a strength of the electric field.

By hiding the insulating nail in the electrode space through the first electrode plate, the conductive connecting cylinder and the second electrode plate, compared with the insulating nail exposed in the electrode space, the utilization rate of the insulating nail is improved. By means of the insulating nail, the first electrode plate, the conductive connecting cylinder and the second electrode plate are structurally reinforced in a detachable manner, thereby simplifying the fixing manner of the dielectric barrier-free electrode subassembly in the insulating groove body, and taking into account the removability and stability of the dielectric barrier-free electrode subassembly in the insulating groove body.

Optionally, the plurality of the conductive connecting cylinders are uniformly arranged in the electrode space;
a quantity of the insulating nails is equal to a quantity of the conductive connecting cylinders, and each of the insulating nails is respectively inserted into a corresponding conductive connecting cylinder.

The beneficial effects of the above-mentioned technical solution are that, by uniformly distributing the plurality of conductive connecting cylinders in the electrode space, the conductivity uniformity of the dielectric barrier-free electrode subassembly is ensured, which helps to improve the discharge uniformity; and each insulating nail is respectively aligned with each conductive connecting cylinder, thereby improving the stability of the dielectric barrier-free electrode subassembly inside the insulating groove body.

Optionally, the plasma circulation assembly further includes a high-frequency voltage conduction prevention subassembly and a high-frequency navigation plug;
the high-frequency voltage conduction prevention subassembly is inserted in the first groove, two ends of the high-frequency voltage conduction prevention subassembly are respectively provided as a voltage output end and an access end, the voltage output end is embedded in the conductive clamping seat, and the access end and the high-frequency navigation plug are both located outside the first fixed frame; and
the high-frequency navigation plug is respectively provided with a voltage input portion and a voltage transfer portion electrically connected to the voltage input portion, the voltage transfer portion is embedded in the access end, and the voltage transfer portion is electrically connected to the voltage output end.

The beneficial effects of the above-mentioned technical solution are that, with the aid of the high-frequency voltage conduction prevention subassembly, the high-frequency navigation plug outside the first fixed frame is fixedly connected and electrically connected to the conductive clamping seat inside the first fixed frame, the utilization rate of the high-frequency voltage conduction prevention subassembly and the conductive clamping seat is improved, the difficulty of the dual-purpose connection between the high-frequency navigation plug outside the first fixed frame and the dielectric barrier-free electrode subassembly inside the first fixed frame is reduced, and with the aid of the plugability of the high-frequency navigation plug, it is convenient to connect a high-frequency alternating current power supply outside the dielectric barrier-free electrode subassembly.

Optionally, the high-frequency voltage conduction prevention subassembly comprises a first insulating sleeve, a vacuum sealing ring, a second insulating sleeve, a conductive strut, a nut and a protective sleeve;
the first insulating sleeve is arranged opposite to the second insulating sleeve and has an accommodating space with the second insulating sleeve, the vacuum sealing ring seals the accommodating space, and both the first insulating sleeve and the second insulating sleeve are embedded in the first groove bottom;
the conductive strut is successively inserted into the first insulating sleeve, the vacuum sealing ring and the second insulating sleeve, and conductive strut is provided with the voltage output end extending outside the first insulating sleeve;
the nut is embedded in the protective sleeve, the protective sleeve is nested outside the second insulating sleeve, the protective sleeve is located outside the first fixed frame, and the protective sleeve is provided with the access end; and
the voltage transfer portion is in contact with the conductive strut through the nut.

The beneficial effects of the above-mentioned technical solution are that, a spatial orientation of the first insulating sleeve and the second insulating sleeve is solidified through the first groove bottom, so that the first groove bottom, the first insulating sleeve, the vacuum sealing ring and the second insulating sleeve together form a first insulating hollow sleeve member, the space utilization rate of the first groove is improved, and the stability between the first fixed frame and the high-frequency voltage conduction prevention subassembly is improved; the first insulating hollow sleeve member has the property of blocking the electric field of the conductive strut, which helps to reduce an electric field interference of the conductive strut on the dielectric barrier-free electrode subassembly; and the conductive strut has the property of both fixing and electrically connecting with the conductive clamping seat. The convenience of dual-purpose connection between the high-frequency voltage conduction prevention subassembly and the dielectric barrier-free electrode subassembly is improved.

The nut and the second insulating sleeve are solidified in the spatial orientation through the protective sleeve, so that the protective sleeve, the nut and the second insulating sleeve together form a second insulating hollow sleeve member, the stability of the second insulating hollow sleeve member is ensured, and the utilization rate of the protective sleeve and the second insulating sleeve is improved; compared with the protective sleeve being embedded in the first fixed frame, the protective sleeve is prevented from occupying a space in the first fixed frame, which helps to narrow and thin the first fixed frame; and the voltage transfer portion and the conductive strut are solidified in a spatial orientation by means of the nut and the access end cooperating with each other. It helps to improve the stability of dual-purpose butting between the high-frequency navigation plug and the high-frequency voltage conduction prevention subassembly.

Optionally, the plasma cleaning head for an optical member further includes a clip assembly having a hollow shape; and
the clip assembly is mounted on the lens frame, and the clip assembly is nested at a periphery of the optical lens body, a gap is left between the optical lens body and the lens frame, and the clip assembly is adapted to seal the gap.

The beneficial effects of the above-mentioned technical solution are that, with the aid of the clip assembly, both the lens frame and the optical lens body are reinforced and the optical lens body is protected, taking into account the firmness and airtightness between the lens frame and the optical lens body.

Optionally, the yield assembly includes a second fixed frame and a flexible gasket mounted on the second fixed frame;
the second fixed frame is detachably butted to the lens frame, and the flexible gasket surrounds among the second fixed frame, the lens frame and the optical lens body, and the flexible gasket seals the gap.

The beneficial effects of the above-mentioned technical solution are that the second fixed frame solidifies the flexible gasket and the lens frame and the optical lens body in spatial orientation, so as to improve the utilization rate of the second fixed frame and improve the stability between the clip assembly and the lens frame.

Optionally, the flexible gasket is removably mounted on the second fixed frame.

The beneficial effects of the above-mentioned technical solution are that it is easy to disassemble and assemble the clip assembly, taking into account the removability and stability of the clip assembly.

Another aspect of the present disclosure provides a plasma cleaning device comprising the plasma cleaning head for an optical member according to the first aspect.

The beneficial effects of the above-mentioned technical solution are that, in the plasma cleaning head for an optical member, on the one hand, compared with providing an ejection port adapted to eject a plasma, the outlet port has the performance of expanding an outflow area of the plasma and dispersing the outflow plasma, promoting the plasma to homogenize the gas flow velocity inside and outside the plasma circulation assembly, helping to alleviate the sharp drop of the gas flow velocity of the plasma outside the plasma circulation assembly; on the other hand, the lens frame has the performance of solidifying the spatial orientation of the plasma circulation assembly and the optical lens body, preventing the plasma exiting the outlet port from being obstructed, and defining a space where the plasma flows from the outlet port to the optical lens body, promoting the outlet port and the optical lens body to be in a relatively static state so as to prevent the outlet port and the optical lens body from being in a relatively running state, not only improving a utilization rate of the lens frame, but also improving a stability between the outlet port and the optical lens body, helping to improve dispersion and stability of the plasma flowing from the outlet port to the optical lens body, thereby helping to promote the optical lens body to absorb energy from the plasma, helping to improve strength and efficiency of the plasma for cleaning the optical lens body over a large area, and freeing from a dilemma of the spray port restricting the performance of the plasma cleaning an optical member.

### BRIEF DESCRIPTION OF THE DRAWINGS

FIG. 1 is a schematic diagram showing a structure of a plasma cleaning device in a self-contained state in the prior art;

FIG. 2 is a schematic cross-sectional diagram of a plasma torch in FIG. 1;

FIG. 3 is a schematic diagram showing a structure of a plasma cleaning head for an optical member in a disassembled state according to an embodiment of the present disclosure;

FIG. 4 is a schematic diagram showing a structure of a plasma circulation assembly in FIG. 3 in a self-contained state;

FIG. 5 is a schematic diagram showing a structure of a dielectric barrier-free electrode subassembly in FIG. 4 in a disassembled state;

FIG. 6 is a schematic diagram of a conductive clamping seat in FIG. 5;

FIG. 7 is a schematic diagram of a conductive connecting cylinder in FIG. 5;

FIG. 8 is a schematic diagram showing a structure of a high-frequency voltage conduction prevention subassembly and a high-frequency navigation plug in a disassembled state according to an embodiment of the present disclosure;

FIG. 9 is a partial cross-sectional schematic diagram of another plasma flow module in a self-contained state according to an embodiment of the present disclosure;

FIG. 10 is a schematic cross-sectional diagram of A in FIG. 9;

FIG. 11 is a schematic diagram showing a structure of another plasma circulation assembly in a self-contained state according to an embodiment of the present disclosure;

FIG. 12 is a schematic diagram showing a structure of another plasma circulation assembly in a self-contained state according to an embodiment of the present disclosure;

FIG. 13 is a schematic diagram showing a structure of another plasma cleaning head for an optical member in a disassembled state according to an embodiment of the present disclosure;

FIG. 14 is a schematic structural diagram of B in FIG. 13;

FIG. 15 is a schematic diagram showing a structure of a plasma cleaning device in a self-contained state according to an embodiment of the present disclosure; and

FIG. 16 is a schematic diagram showing a structure of the plasma cleaning head for an optical member in FIG. 15 in a self-contained state.

### REFERENCE NUMERALS

1′—gas supply device, 2′—gas control device, 3′—high—voltage radio frequency generation device, 4′—flexible tube, 5′—plasma torch, 6′—optical member, 1—plasma cleaning head for an optical member, 2—optical lens body, 3—vacuum cavity assembly;
11—plasma circulation assembly, 12—lens frame, 13—clip assembly, 14—adapter assembly, 51′—radio frequency electrode, 52′—insulating cylinder, 53′—spray head;
111—first fixed frame, 112—dielectric barrier—free electrode subassembly, 113—high—frequency voltage conduction prevention subassembly, 114—high—frequency navigation plug, 131—second fixed frame, 132—flexible gasket, 531′—air passage, 532′—ejection port;
1111—outlet port, 1121—insulating groove body, 1122—yield screw, 1123—conductive clamping seat, 1124—first electrode plate, 1125—conductive connecting cylinder, 1126—second electrode plate, 1127—insulating nail, 1131—first insulating sleeve, 1132—vacuum sealing ring, 1133—second insulating sleeve, 1134—conductive strut, 1135—nut, 1136—protective sleeve.

### DETAILED DESCRIPTION OF THE INVENTION

To make the above-mentioned objects, features and advantages of the present disclosure more apparent, a detailed description of specific embodiments of the present disclosure will be made with reference to the accompanying drawings.

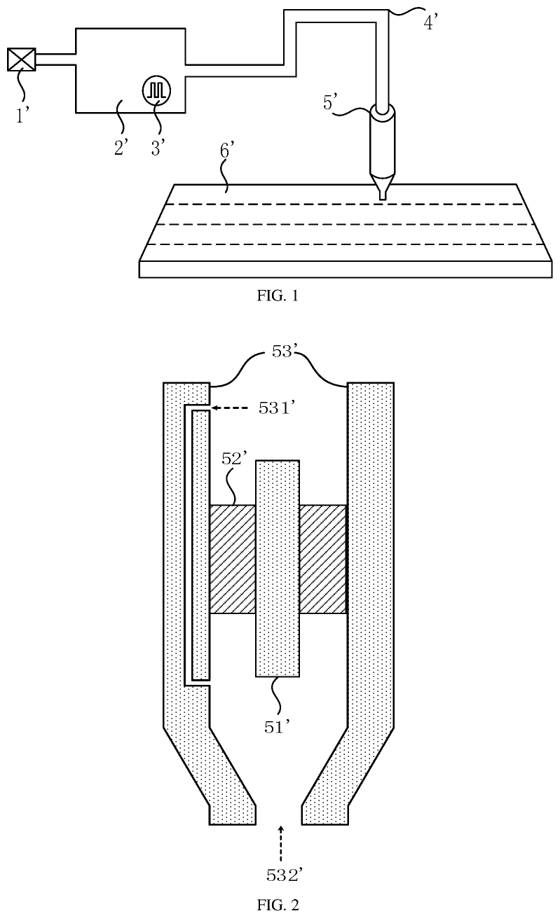

Referring to FIG. 1, there is shown a plasma cleaning device of the prior art, including a gas supply device 1′, a gas control device 2′, a high-voltage radio frequency generation device 3′, a flexible tube 4′ and a plasma torch 5′, the high-voltage radio frequency generation device 3′ being built into the gas control device 2′, the gas control device 2′ being in communication with the gas supply device 1′ such that the gas supply device 1′ provides a working gas to the gas control device 2′.

A radio frequency cable and a gas transmission channel are provided in the flexible tube 4′, and with reference to FIG. 2, a cross-sectional structure of the plasma torch 5′ in FIG. 1 is shown, including a radio frequency electrode 51′, an insulating cylinder 52′ having a hollow shape and a spray head 53′ having a hollow shape, wherein the radio frequency electrode 51′ is inserted in the insulating cylinder 52′, the radio frequency electrode 51′ and the insulating cylinder 52′ are both built in the spray head 53′, and the radio frequency electrode 51′ is electrically connected to the high-voltage radio frequency generation device 1′ via the above-mentioned radio frequency cable, so that the high-voltage radio frequency generation device 1′ provides a high voltage for the high-frequency electrode 51′; the spray head 53′ is grounded, and an air passage 531′ is provided on a body wall thereof, and the air passage 531′ is in communication with a gas transmission channel inserted in an open end of the spray head 53′, so that the above-mentioned working gas is transmitted to the air passage 531′ via the gas transmission channel, and during the process that the radio frequency electrode 51′ is applied with a high voltage, the radio frequency electrode 51′ ionizes the working gas flowing out of the air passage 531′, forming an arc discharge, and then generating plasma.

The other open end of the spray head 53′ is provided with an ejection port 532′, the ejection port 532′ is distributed directly in front of the radio frequency electrode 51′, the ejection port 532′ faces the optical member 6′ and is provided with a larger spacing from the optical member 6′, so that the ejection port 532′ sprays the above-mentioned plasma with a higher temperature property onto the optical member 6′, and the optical member 6′ generates a temperature gradient due to energy absorption from the active particles in the above-mentioned plasma, so as to reduce the thermal stress of the pollutants, thereby reducing the adsorption force of the pollutants on the optical member 6′, and allowing some pollutants to leave the optical member 6′, and a plasma cleaning of the optical member 6′ is achieved.

Since the ejection port 532′ concentrates the jet of the plasma, the gas flow velocity of the plasma outside the ejection port 532′ sharply decreases, thereby hindering the energy absorption from the plasma by the optical member 6′ and restricting the performance of the plasma cleaning the optical member 6′. In order to overcome the technical disadvantage, embodiments of the present disclosure provide a plasma cleaning head for an optical member and a plasma cleaning device.

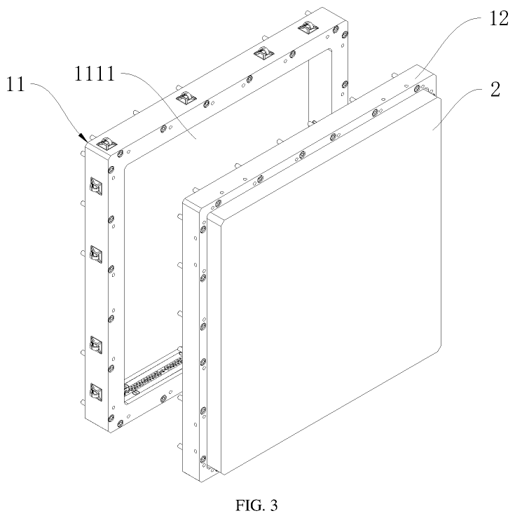

Referring to FIG. 3, there is shown a disassembled structure of a plasma cleaning head for an optical member according to an embodiment of the present disclosure, the plasma cleaning head for an optical member including a plasma circulation assembly 11 having a hollow shape and a lens frame 12 mounted on the plasma circulation assembly 11. For example, a shape of the plasma circulation assembly 11 is the same as a shape of the lens frame 12, and the lens frame 12 is an insulating frame having a square body.

The plasma circulation assembly 11 is provided with an outlet port 1111 which is larger than the ejection port 532′ adapted to eject the plasma, wherein the outlet port 1111 is adapted to diffuse the plasma, and the outlet port 1111 serves both to expand an outlet flow area for the plasma and to disperse the performance of the outflow plasma, so as to promote the plasma to homogenize the gas flow velocity inside and outside the plasma circulation assembly 11, and help to alleviate the phenomenon of a sharp drop in the gas flow velocity of the plasma outside the plasma circulation assembly 11.

Illustratively, the ejection port 532′ has a circular shape, the outlet port 1111 has a square shape, and a length of a diagonal line in the outlet port 1111 is greater than a length of a diameter in the ejection port 532′, so that the outlet port 1111 is larger than the ejection port 532′. For example, the length of the diagonal line in the outlet port 1111 is set in the order of centimeters, and the length of the diameter in the ejection port 532′ is set in the order of millimeters.

The lens frame 12 is in communication with the outlet port 1111 and surrounds the outlet port 1111, and the lens frame 12 is adapted to embed the optical lens body 2 so that the optical lens body 2 is arranged opposite to the outlet port 1111. The lens frame 12 combines the properties of performing spatial orientation curing on the plasma circulation assembly 11 and the optical lens body 2, preventing the outflow plasma from being obstructed from the outlet port 1111 and defining a space for the plasma to flow from the outlet port 1111 to the optical lens body 2, and promoting the outlet port 1111 and the optical lens body 2 to be in a relatively static state, in case the outlet port 1111 and the optical lens body 2 are in a relative running state. Both the utilization rate of the lens frame 12 and the stability between the outlet port 1111 and the optical lens body 2 are improved. For example, the optical lens body 2 is a square copper lens or a glass lens, and the optical lens body 2 covers the outlet port 1111.

It should be noted that, unlike the manner of concentrating the ejected plasma at the ejection port 532′, the manner of dispersing the plasma at the outlet port 1111 is suitable for dispersing the plasma from the outlet port 1111. The outlet port 1111 and the optical lens body 2 are in a relatively stationary state, which refers to a state where the spatial orientation of the optical lens body 2 with respect to the outlet port 1111 remains unchanged. The outlet port 1111 and the optical lens body 2 are in a relative running state, which means a state where the spatial orientation of the optical lens body 2 with respect to the outlet port 1111 changes.

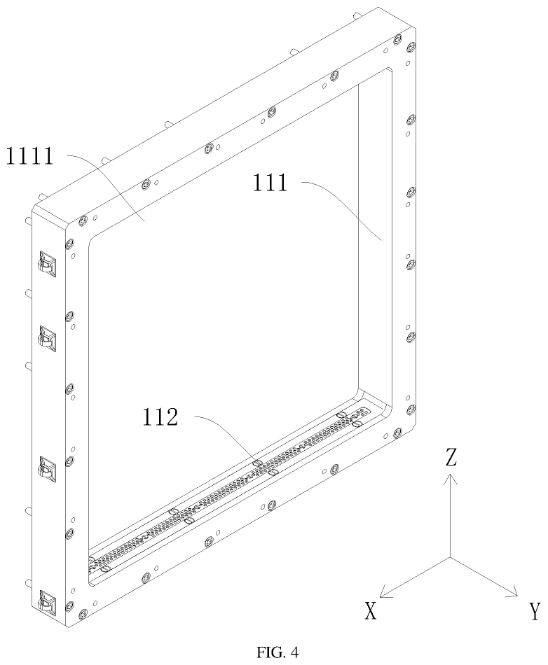

Alternatively, with reference to FIG. 4, the plasma circulation assembly 11 includes a first fixed frame 111 having a hollow shape and a dielectric barrier-free electrode subassembly 112 embedded in the first fixed frame 111, wherein the first fixed frame 111 is provided with the outlet port 1111, and the outlet port 1111 is located at one side of the dielectric barrier-free electrode subassembly 112. With the aid of the first fixed frame 111, the dielectric barrier-free electrode subassembly 112 is urged to perform space avoidance on the outlet port 1111. Compared with the situation that the outlet port is distributed directly in front of the dielectric barrier-free electrode subassembly 112, it helps to homogenize the distribution of the plasma in the first fixed frame 111, facilitating the outlet port 1111 to homogenize the outflow plasma. For example, the first fixed frame 111 is a conductive frame or an insulating frame in the shape of a square.

The lens frame 12 is detachably butted to the first fixed frame 111, so that the lens frame 12 is detachably mounted on the plasma circulation assembly 11, so as to facilitate the disassembly and assembly of the lens frame 12 and the plasma circulation assembly 11. For example, the lens frame 12 and the first fixed frame 111 are snap-in connected or threadedly connected via a plurality of first fixing pieces distributed at intervals.

The optical lens body 2 is provided with a lens surface to be cleaned, and the lens surface to be cleaned is arranged parallel to and opposite to a plane where the outlet port 1111 is located, so that the lens surface to be cleaned and the outlet port 1111 are distributed at intervals. Compared with the lens surface to be cleaned covering the outlet port 1111, the space from the outlet port 1111 to the lens surface to be cleaned is extended, facilitating the dispersed flow of plasma in the space from the outlet port 1111 to the lens surface to be cleaned, facilitating the relatively uniform cleaning of the lens surface to be cleaned by the plasma. For example, the optical lens body 2 is a transparent lens sheet having a square body. The lens surface to be cleaned is provided on a surface, facing the outlet port 1111, of the transparent lens sheet, and the lens surface to be cleaned is parallel to the plane where the outlet port 1111 is located and is vertically spaced from the plane where the outlet port 1111 is located.

Optionally, with reference to FIG. 4, the first fixed frame 111 is further provided with a first groove, the bottom of the first groove is provided as a first groove bottom, a notch of the first groove is provided as a first notch communicating with the outlet port 1111, the first notch is distributed inside the first fixed frame 111, the dielectric barrier-free electrode subassembly 112 is detachably mounted in the first groove, and by means of the first groove, the dielectric barrier-free electrode subassembly 112 is promoted to be detachably accommodated inside the first fixed frame 111, which not only improves the space utilization rate inside the first fixed frame 111, is also convenient to assemble and disassemble the first fixed frame 111 and the dielectric barrier-free electrode subassembly 112 to help maintain the plasma circulation assembly 11. For example, the first fixed frame includes a first side wall and a second side wall which are parallel to each other, and the first side wall is provided with a first groove with a notch facing the second side wall.

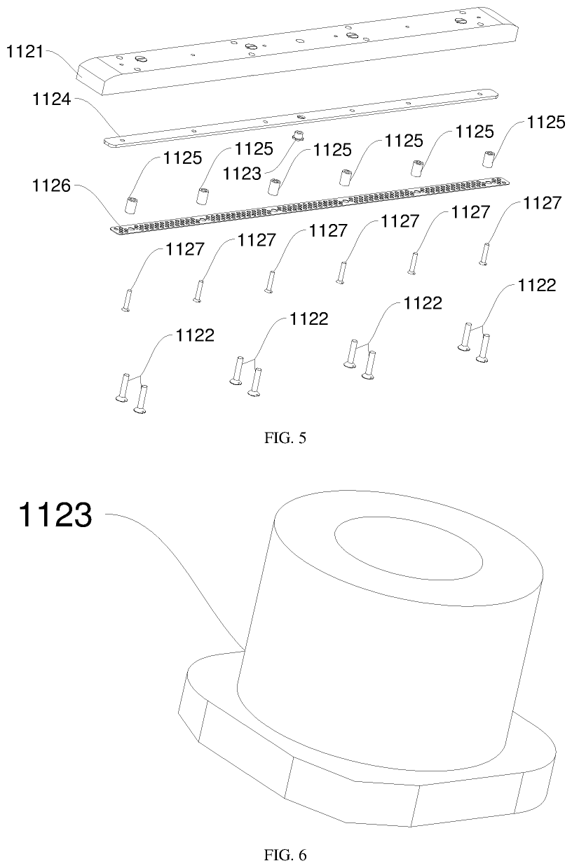

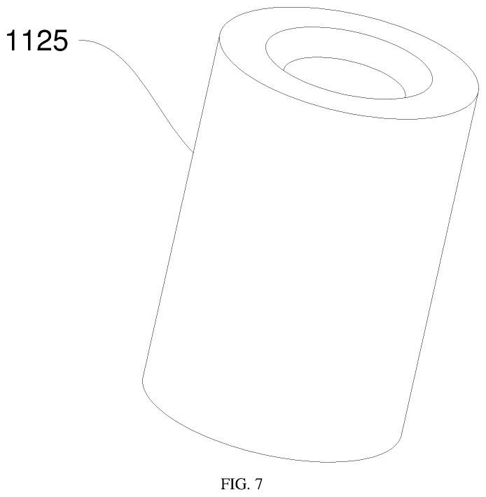

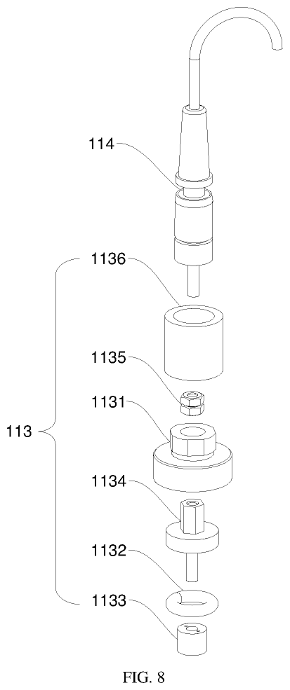

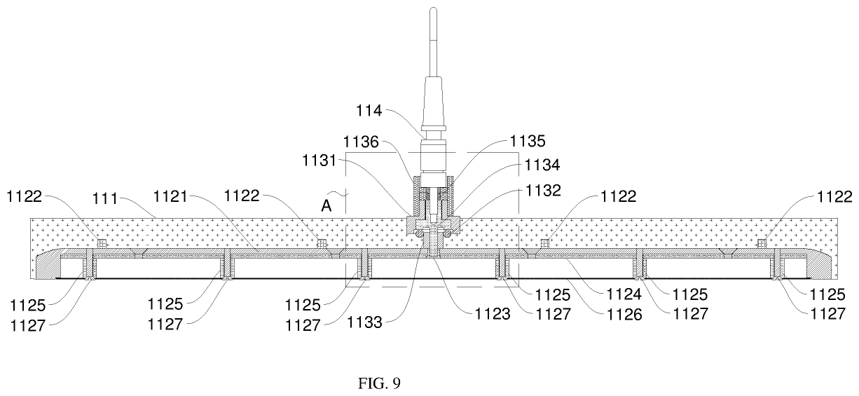

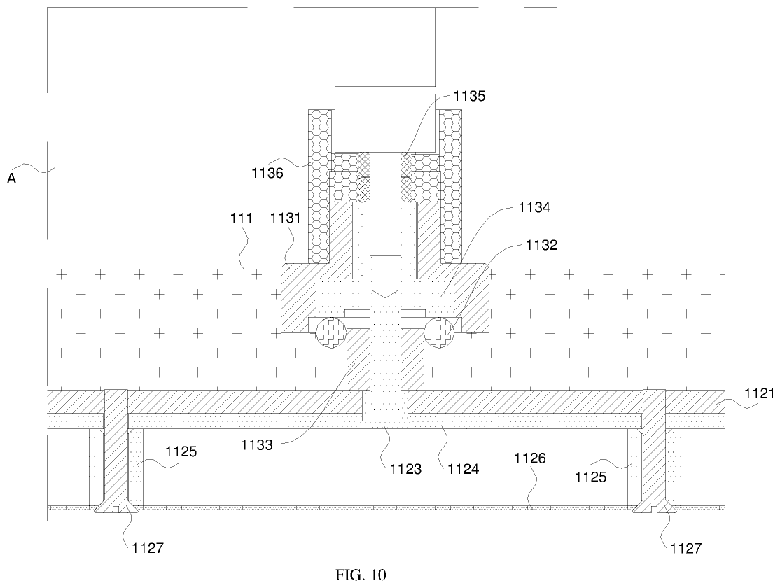

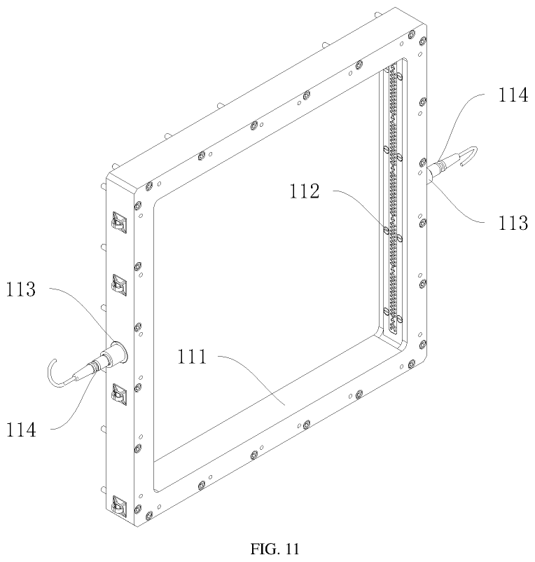

Alternatively, referring to FIGS. 5, 6, 7, 9, and 10, the dielectric barrier-free electrode subassembly 112 includes an insulating slot 1121, a yield screw 1122, a conductive clamping seat 1123, a first electrode plate 1124, a conductive connecting cylinder 1125, a second electrode plate 1126, and an insulating nail 1127.

The insulating groove body 1121 is provided with a second groove, a bottom of the second groove is provided as a second groove bottom, a notch of the second groove is provided as a second notch, the insulating groove body 1121 is embedded in the first groove, and a plane where the second notch is located coincides with a plane where the first notch is located. Compared with a case where the notch of the insulating groove body 1121 is exposed outside the first groove, the insulating groove body 1121 better fits into the first groove so as to prevent the first groove from being too large, facilitating narrowing or thinning of the plasma circulation assembly 11.

The yield screw 1122 is inserted into a body of the insulating groove body 1121, and a screw tail of the yield screw 1122 is threadedly connected to the first groove bottom. With the aid of the yield screw 1122, the insulating groove body 1121 is urged to be fixed inside the first groove in a detachable manner; and the body of the insulating groove body 1121 has the properties of both covering the yield screw 1122 and spatially isolating the yield screw 1122 from the second groove, so as to urge the yield screw 1122 to avoid the second groove in the insulating groove body 1121, so as to prevent the yield screw 1122 from completely exposing the first groove and generating structural interference to the second groove, thereby improving the utilization rate of the insulating groove body 1121.

Optionally, at least two yield screws 1122 are uniformly arranged in the body of the insulating groove body 1121 to reinforce the insulating groove body 1121. For example, eight yield screws 1122 are arranged in the body of the insulating groove body 1121 in a two-dimensional array of two rows and four columns, wherein both a row spacing and a column spacing are fixed, and the row spacing is less than the column spacing.

The conductive clamping seat 1123, the first electrode plate 1124, the conductive connecting cylinder 1125, the second electrode plate 1126 and the insulating nail 1127 are all arranged in the second groove, wherein the conductive clamping seat 1123 is embedded in the second groove bottom and the first electrode plate 1124, the first electrode plate 1124 and the second electrode plate 1126 are arranged opposite to each other and form an electrode space, the conductive connecting cylinder 1125 is arranged in the electrode space, and two ends of the conductive connecting cylinder 1125 respectively abut against the first electrode plate 1124 and the second electrode plate 1126.

In the second groove, the conductive clamping seat 1123 has both the performances of fixedly connecting and electrically connecting the first electrode plate 1124; by means of a layered electrode structure formed by the first electrode plate 1124 and the second electrode plate 1126 together, the conductive connecting cylinder 1125 is stable in the electrode space, and the conductive connecting cylinder 1125 has the performances of electrically connecting the first electrode plate 1124 and the second electrode plate 1126; the conductive clamping seat 1123 is promoted to be stably connected to the second electrode plate 1126 via the first electrode plate 1124 and the conductive connecting cylinder 1125 in sequence in a dual-purpose manner, so as to improve the utilization rate of the conductive clamping seat 1123, the first electrode plate 1124, the conductive connecting cylinder 1125 and the second electrode plate 1126, improve the stability of the electrode space and the space utilization rate of the second groove, and expand an electrode area which helps to increase a strength of the electric field.

The insulating nail 1127 is successively inserted into the first electrode plate 1124, the conductive connecting cylinder 1125 and the second electrode plate 1126, and the nail tail of the insulating nail 1127 is embedded into the second groove bottom. For example, the insulating nail 1127 is respectively a plastic screw, and the nail tail of the plastic screw is inserted into the second groove bottom and is in threaded connection with the second groove bottom.

By hiding the insulating nail 1127 in the electrode space through the first electrode plate 1124, the conductive connecting cylinder 1125 and the second electrode plate 1126, compared with the insulating nail 1127 exposed in the electrode space, the utilization rate of the insulating nail 1127 is improved. By means of the insulating nail 1127, the first electrode plate 1124, the conductive connecting cylinder 1125 and the second electrode plate 1126 are structurally reinforced in a detachable manner, thereby simplifying the fixing manner of the dielectric barrier-free electrode subassembly 112 in the insulating groove body 2, and taking into account the removability and stability of the dielectric barrier-free electrode subassembly 112 in the insulating groove body 2.

Optionally, the conductive clamping seat 1123 is a de-tipped conductive clamping seat, and there is no tip with a small radius of curvature on the de-tipped conductive clamping seat, so that the de-tipped conductive clamping seat is provided with the property of preventing tip power generation, so as to prevent a positive polarity corona or a negative polarity corona from being induced near the de-tipped conductive clamping seat, and the dilemma of using an insulating dielectric barrier layer to inhibit arc light induced by the tip is avoided. For example, the de-tipped conductive clamping seat is a smooth metal cavity treated by processes such as grinding and polishing.

Optionally, the first electrode plate 1124 is a first de-tipped electrode plate with a plurality of positioning holes, and there is no tip with a small radius of curvature on the first de-tipped electrode plate, so that the first de-tipped electrode plate has the property of preventing tip power generation, so as to prevent a positive polarity corona or a negative polarity corona from being induced in the vicinity of the first de-tipped electrode plate, and the dilemma of using an insulating dielectric barrier layer to inhibit arc light induced by the tip is avoided. For example, the first de-tipped electrode plate is a smooth aluminium alloy plate treated by processes such as grinding and polishing, and the conductive clamping seat 1123 and the insulating nail 1127 are respectively embedded into corresponding positioning holes, so that the conductive clamping seat 1123 is embedded in the first de-tipped electrode plate and the insulating nail 1127 is inserted in the first de-tipped electrode plate.

Optionally, the conductive connecting cylinder 1125 is a de-tipped conductive cylinder having a hollow shape, and there is no tip with a small radius of curvature on the de-tipped conductive cylinder, so that the de-tipped conductive cylinder is provided with the property of preventing tip power generation, so as to prevent a positive polarity corona or a negative polarity corona from being induced near the de-tipped conductive cylinder, and the dilemma of using an insulating dielectric barrier layer to inhibit arc light induced by the tip is avoided. For example, the de-tipped conductive cylinder is a smooth copper cylinder treated by processes such as grinding and polishing.

Optionally, a plurality of conductive connecting cylinders 1125 are uniformly arranged in the electrode space, and by uniformly arranging the plurality of conductive connecting cylinders 1125 in the electrode space, the conductivity uniformity of the dielectric barrier-free electrode subassembly 112 is ensured to help improve the discharge uniformity. For example, six conductive connecting cylinders 1125 are arranged in a one-dimensional array and at equal intervals in the electrode space.

Optionally, the second electrode plate 1126 is a mesh-shaped second de-tipped electrode plate, a hole density of the second de-tipped electrode plate is greater than a hole density of the first de-tipped electrode plate, and there is no tip with a small radius of curvature on the second de-tipped electrode plate, so that the second de-tipped electrode plate has the property of preventing tip power generation, so as to prevent a positive polarity corona or a negative polarity corona from being induced in the vicinity of the second de-tipped electrode plate, and the dilemma of using an insulating dielectric barrier layer to inhibit arc light induced by the tip is avoided. For example, the second de-tipped electrode plate is a smooth aluminum alloy plate treated by processes such as grinding and polishing.

Optionally, a quantity of insulating nails 1127 is equal to a quantity of conductive connecting cylinders 1125, each insulating nail 1127 is respectively inserted in a corresponding conductive connecting cylinder 1125, and each insulating nail 1127 is respectively aligned with each conductive connecting cylinder 1125, so as to improve the stability of the dielectric barrier-free electrode subassembly 112 inside the insulating groove body 1121. For example, the quantity of insulating nails 1127 is six.

Optionally, referring to FIGS. 8, 9 and 10, the plasma circulation assembly 11 further includes a high-frequency voltage conduction prevention subassembly 113 and a high-frequency navigation plug 114.

The high-frequency voltage conduction prevention subassembly 113 is inserted in the first groove, two ends of the high-frequency voltage conduction prevention subassembly 113 are respectively provided as a voltage output end and an access end, the voltage output end is embedded in the conductive clamping seat 1123, the access end and the high-frequency navigation plug 114 are both located outside the first fixed frame 111, the high-frequency navigation plug 114 is respectively provided with a voltage input portion and a voltage transfer portion electrically connected to the voltage input portion, the voltage transfer portion is embedded in the access end, and the voltage transfer portion is electrically connected to the voltage output end.

With the aid of the high-frequency voltage conduction prevention subassembly 113, the high-frequency navigation plug 114 outside the first fixed frame 111 is fixedly connected and electrically connected to the conductive clamping seat 1123 inside the first fixed frame 111, so as to improve the utilization rate of the high-frequency voltage conduction prevention subassembly 113 and the conductive clamping seat 1123, facilitate the dual-purpose connection between the high-frequency navigation plug 114 outside the first fixed frame 111 and the dielectric barrier-free electrode subassembly 112 inside the first fixed frame 111, and facilitate the external connection of a high-frequency alternating current power supply to the dielectric barrier-free electrode subassembly 112 with the aid of the pluggability of the high-frequency navigation plug 114.

Optionally, referring to FIGS. 8, 9, and 10, the high-frequency voltage conduction prevention subassembly 113 includes a first insulating sleeve 1131, a vacuum seal ring 1132, a second insulating sleeve 1133, a conductive strut 1134, a nut 1135, and a protective sleeve 1136.

The first insulating sleeve 1131 is arranged opposite to the second insulating sleeve 1133, and an accommodating space is left between the first insulating sleeve 1131 and the second insulating sleeve 1133. The vacuum sealing ring 1132 is embedded in the accommodating space and seals the accommodating space. The first insulating sleeve 1131 and the second insulating sleeve 1133 are both embedded in the first groove bottom, the conductive strut 1134 is successively inserted into the first insulating sleeve 1131, the vacuum sealing ring 1132 and the second insulating sleeve 1133, and a voltage output end extending to the outside of the first insulating sleeve 1131 is provided on the conductive strut 1134, and the voltage output end is detachably inserted into the conductive clamping seat 1123.

A spatial orientation of the first insulating sleeve 1131 and the second insulating sleeve 1133 is solidified through the first groove bottom, so that the first groove bottom, the first insulating sleeve 1131, the vacuum sealing ring 1132 and the second insulating sleeve 1133 together form a first insulating hollow sleeve member, the space utilization rate of the first groove is improved, and the stability between the first fixed frame 111 and the high-frequency voltage conduction prevention subassembly 113 is improved; the first insulating hollow sleeve member has the property of blocking the electric field of the conductive strut 1134, which helps to reduce an electric field interference of the conductive strut 1134 on the dielectric barrier-free electrode subassembly 112; and the conductive strut 1134 has the property of both fixing and electrically connecting with the conductive clamping seat 1123. The convenience of dual-purpose connection between the high-frequency voltage conduction prevention subassembly 113 and the dielectric barrier-free electrode subassembly 112 is improved.

The nut 1135 is embedded in the protective sleeve 1136, the protective sleeve 1136 is nested outside the second insulating sleeve 1133, the nut 1135 and the second insulating sleeve 1133 are solidified in spacial orientation by the protective sleeve 1136, so that the protective sleeve 1136, the nut 1135 and the second insulating sleeve 1133 together form a second insulating hollow sleeve, ensuring the stability of the second insulating hollow sleeve, and improving the utilization rate of the protective sleeve 1136 and the second insulating sleeve 1133. Compared with the protective sleeve 1136 being embedded in the first fixed frame 111, the protective sleeve 1136 is exposed outside the first fixed frame 111, preventing the protective sleeve 1136 from occupying a space in the first fixed frame 111, and helping to narrow and thin the first fixed frame 111. For example, the nut 1135 is a conductive nut made of metal or an insulating nut made of plastic, and the protective sleeve 1136 is a insulating cylinder having a hollow shape.

The protective sleeve 1136 is provided with an access end, and the voltage transfer portion is successively embedded in the access end, the nut 1135 and the conductive strut 1134, so as to facilitate the voltage transfer portion to be connected with the conductive strut 1134 in a dual-purpose manner after passing through the nut 1135 from the access end, and thus the spacial orientation of the voltage transfer portion and the conductive strut 1134 is solidified by means of the nut 1135 cooperating with the access end, which helps to improve the stability of the dual-purpose butting between the high-frequency navigation plug 114 and the high-frequency voltage conduction prevention subassembly 113.

Optionally, the conductive strut 1134 is provided with a cavity portion disposed in the first insulating sleeve 1131, a quantity of nuts 1135 is two, the two nuts 1135 are oppositely disposed and form a hollow double-nut structure, the double-nut structure is disposed on the cavity portion and is in communication with the cavity portion, and the voltage transfer portion can be pluggably embedded in the double-nut structure and the cavity portion.

Optionally, the plurality of sets of dielectric barrier-free electrode subassemblies 112 are uniformly arranged in the first groove, and space is uniformly allocated for the plurality of sets of dielectric barrier-free electrode subassemblies 112 in the first groove, so as to improve the space utilization rate of the first groove and help to homogenize the electric field. For example, three sets of non-dielectric barrier electrode subassemblies 112 are arranged in a right triangle in the first groove, and the first groove is in a right triangle.

Optionally, referring to FIG. 11, there are two sets of dielectric barrier-free electrode subassemblies 112, with the two sets of dielectric barrier-free electrode subassemblies 112 arranged with central symmetry in two first grooves.

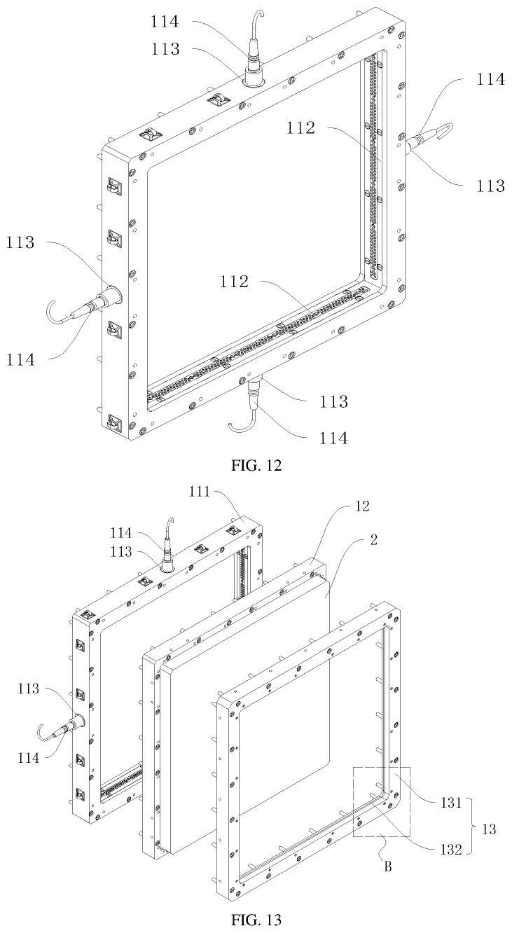

Optionally, referring to FIG. 12, there are four sets of dielectric barrier-free electrode subassemblies 112, and the four sets of dielectric barrier-free electrode subassemblies 112 are arranged in a square shape in the first groove having an annular shape.

Optionally, with reference to FIG. 13, the plasma cleaning head for an optical member further includes a clip assembly 13 having a hollow shape, wherein the clip assembly 13 is mounted on the lens frame 12, and the clip assembly 13 is nested on a periphery of the optical lens body 2, a gap is left between the optical lens body 2 and the lens frame 12, and the clip assembly 13 is suitable for sealing the above-mentioned gap; and by means of the clip assembly 13, both the lens frame 12 and the optical lens body 2 are reinforced and the optical lens body 2 is protected, taking into account the stability and airtightness between the lens frame 12 and the optical lens body 2.

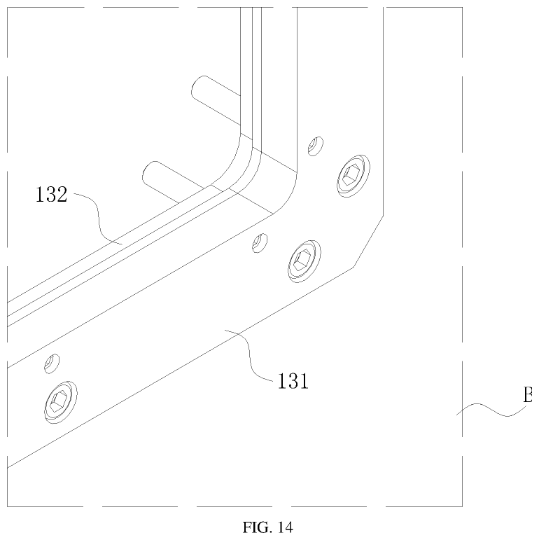

Optionally, referring to FIG. 14, the yield assembly 13 includes a second fixed frame 131 and a flexible gasket 132 mounted on the second fixed frame 131.

With reference to FIGS. 13 and 14, the second fixed frame 131 is detachably butted to the lens frame 12, and the flexible gasket 132 surrounds the second fixed frame 131, the lens frame 12 and the optical lens body 2, and the flexible gasket 132 seals the gap between the optical lens body 2 and the lens frame 12; and the flexible gasket 132 performs spatial orientation curing on the flexible gasket 132, the lens frame 12 and the optical lens body 2 via the second fixed frame 131, so as to improve the utilization rate of the second fixed frame 131 and improve the stability between the clip assembly 13 and the lens frame 12. For example, the flexible gasket 132 is a plastic ring.

Alternatively, the flexible gasket 132 is detachably mounted on the second fixed frame 131, so as to facilitate the disassembly and assembly of the clip assembly 13, and in consideration of the removability and stability of the clip assembly 13, to facilitate the better maintenance of the clip assembly 13. For example, the second fixed frame 131 and the flexible gasket 132 are snap-fitted or threadedly connected via a plurality of second fixing members spaced apart.

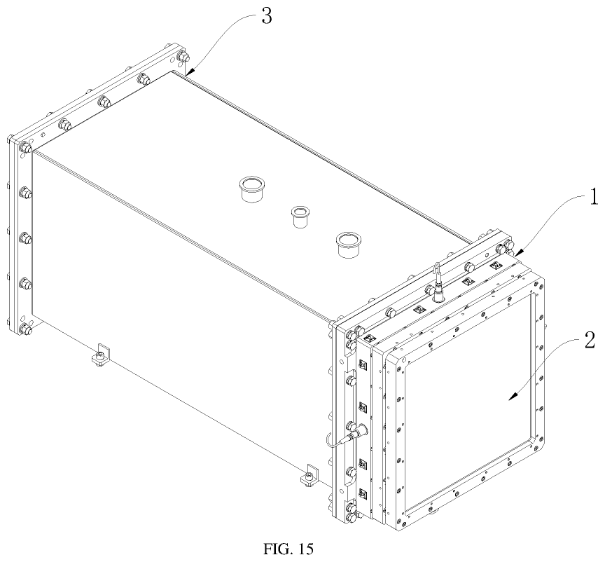

Referring to FIG. 15, an assembled structure of a plasma cleaning device according to an embodiment of the present disclosure includes a vacuum cavity assembly 3 and the above-mentioned plasma cleaning head for an optical member 1, wherein the plasma cleaning head for an optical member 1 has a vacuum cavity and is mounted on the vacuum cavity assembly 3, the vacuum cavity assembly 3 is adapted to communicate with the plasma cleaning head for an optical member 1 and form a vacuum cavity by enclosure of the plasma cleaning head for an optical member 1 with the optical lens body 2, and the vacuum cavity assembly 3 is grounded.

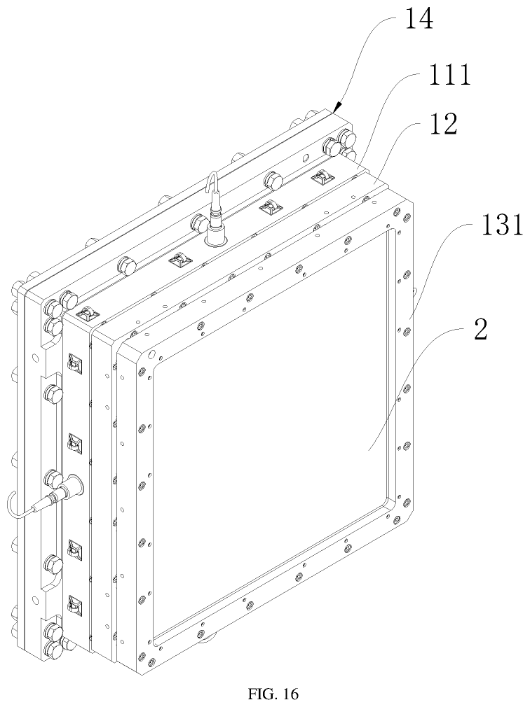

Optionally, referring to FIG. 16, the plasma cleaning head for an optical member 1 includes a plasma circulation assembly 11, a lens frame 12, a clip assembly 13 and an adapter assembly 14, wherein two open ends of the adapter assembly 14 are detachably butted to the plasma circulation assembly 11 and the vacuum cavity assembly 3, respectively, and the adapter assembly 14 is adapted to communicate with the plasma circulation assembly 11 and the vacuum cavity assembly 3, and compared with the plasma circulation assembly 11 directly communicating with the vacuum cavity assembly 3, the plasma cleaning head for an optical member 1 is promoted to expand a vacuum space. The plasma cleaning head for an optical member 1 is adapted to form a vacuum cavity with the vacuum cavity assembly 3 and the optical lens body 2. For example, the adapter assembly 14 is an insulating frame having a hollow shape.

Optionally, the high-frequency alternating current power supply is respectively electrically connected to the high-frequency navigation plug 114 of the plasma circulation assembly 11 and the vacuum cavity assembly 3, so that the first electrode plate and the second electrode plate are both anodic, and the vacuum cavity assembly 3 is cathodic. In a discharge space between the two poles, a glow discharge is formed, and a plasma is generated. The plasma gradually disperses in the vacuum cavity, and a large-area cleaning is respectively performed on the surface of the optical lens body 2 and the inner wall of the vacuum cavity assembly 3, thereby greatly improving the cleaning efficiency of the plasma.

The present disclosure provides a plasma cleaning head for an optical member and a plasma cleaning device, which improve dispersion and stability of plasma during plasma flowing from the outlet port 1111 to the optical lens body 2, help facilitate energy absorption of the plasma by the optical lens body 2, help facilitate surface modification of the optical lens body 2 by the plasma, help improve the strength and efficiency of large-area cleaning of the optical lens body 2 by the plasma, and get rid of the dilemma that an ejection port 532′ restricts the performance of plasma cleaning the optical member.

The terms “first”, “second”, and “third”, etc. as described herein, are used merely to distinguish one device/assembly/subassembly/component or the like and are not to be construed as indicating or implying a relative importance or implicitly indicating the quantity of technical features so indicated, whereby a feature such as “first”, “second”, “third”, etc. is defined either explicitly or implicitly as including at least one of such features, and unless explicitly limited otherwise, the meaning of “plurality” is at least two, e.g. two, three, etc. As would be understood by one of ordinary skill in the art, the specific meanings of the above-mentioned terms in the present disclosure can be understood in detailed conditions.

The terms “aspect”, “optionally”, and “such as” described in this specification mean that a particular feature, structure, material, or characteristic described in connection with the embodiment or implementation is included in at least one embodiment or implementation of the present disclosure, and that the recitation of such terms does not necessarily refer to the same embodiment or implementation, and that the particular feature, structure, material, or characteristic described may be combined in any one or more embodiments or implementations in a suitable manner.

In order to briefly describe and facilitate an understanding of the present disclosure, an XYZ coordinate system is provided in the drawings of the present specification, wherein the direction in the drawing in which the X-axis is located represents a length direction of the device/component designated to be described in the embodiments of the present disclosure, the direction in the drawing in which the Y-axis is located represents a width direction of the device/component designated to be described in the embodiments of the present disclosure, and the direction in the drawing in which the Z-axis is located represents a thickness direction of the device/component designated to be described in the embodiments of the present disclosure. The XYZ coordinate system does not constitute a limitation on the specific structure, and is merely based on the positions in the drawings. The directions or positional relationships described in the embodiments of the present specification are based on the positional relationships of the drawings and do not imply, or imply, a particular orientation that a device or element referred to must have, and are not to be construed as limiting the present disclosure.

Although the present disclosure has been described above, the scope of protection of the present disclosure is not limited thereto. It will be apparent to those skilled in the art that various modifications and variations can be made in the present disclosure without departing from the spirit or scope of the disclosure, and these modifications and variations all fall within the scope of protection of the present disclosure.

1. A plasma cleaning head for an optical member, wherein the plasma cleaning head for an optical member comprises a plasma circulation assembly (11) having a hollow shape and a lens frame (12) mounted on the plasma circulation assembly (11);
the plasma circulation assembly (11) is provided with an outlet port (1111) which is larger than an ejection port adapted to eject a plasma and is adapted to diffuse the plasma; and
the lens frame (12) is in communication with and surrounds the outlet port (1111), and the lens frame (12) is adapted to embed an optical lens body (2) so that the optical lens body (2) is arranged opposite to the outlet port (1111).

2. The plasma cleaning head for an optical member according to claim 1, wherein the plasma circulation assembly (11) comprises a first fixed frame (111) and a dielectric barrier-free electrode subassembly (112) embedded in the first fixed frame (111);
the first fixed frame (111) is provided with the outlet port (1111), and the outlet port (1111) is located at one side of the dielectric barrier-free electrode subassembly (112); and
the lens frame (12) is detachably butted to the first fixed frame (111), a lens surface to be cleaned is provided on the optical lens body (2), and the lens surface to be cleaned is arranged parallel to and opposite to a plane where the outlet port (1111) is located.

3. The plasma cleaning head for an optical member according to claim 2, wherein a first groove is further provided on the first fixed frame (111), a notch of the first groove is provided as a first notch communicating with the outlet port (1111), the first notch is distributed inside the first fixed frame (111), and the dielectric barrier-free electrode subassembly (112) is detachably mounted in the first groove.

4. The plasma cleaning head for an optical member according to claim 3, wherein a plurality of sets of the dielectric barrier-free electrode subassemblies (112) are uniformly arranged in the first groove.

5. The plasma cleaning head for an optical member according to claim 3, wherein a bottom of the first groove is provided as a first groove bottom, and the dielectric barrier-free electrode subassembly (112) comprises an insulating groove body (1121), a yield screw (1122), a conductive clamping seat (1123), a first electrode plate (1124), a conductive connecting cylinder (1125), a second electrode plate (1126) and an insulating nail (1127);
a second groove is provided on the insulating groove body (1121), a notch of the second groove is provided as a second notch, and a bottom of the second groove is provided as a second groove bottom;
the insulating groove body (1121) is embedded in the first groove, and a plane where the second notch is located coincides with a plane where the first notch is located;
the yield screw (1122) is inserted in the insulating groove body (1121), and a screw tail of the yield screw (1122) is in threaded connection with the first groove bottom;
the conductive clamping seat (1123), the first electrode plate (1124), the conductive connecting cylinder (1125), the second electrode plate (1126) and the insulating nail (1127) are all arranged in the second groove;
the conductive clamping seat (1123) is embedded in the second groove bottom and the first electrode plate (1124), the first electrode plate (1124) and the second electrode plate (1126) are oppositely arranged and form an electrode space;
the conductive connecting cylinder (1125) is arranged in the electrode space, and two ends of the conductive connecting cylinder (1125) respectively abut against the first electrode plate (1124) and the second electrode plate (1126); and
the insulating nail (1127) is successively inserted in the first electrode plate (1124), the conductive connecting cylinder (1125) and the second electrode plate (1126), and a nail tail of the insulating nail (1127) is embedded in the second groove bottom.

6. The plasma cleaning head for an optical member according to claim 5, wherein a plurality of the conductive connecting cylinders (1125) are uniformly arranged in the electrode space; and
a quantity of the insulating nails (1127) is equal to a quantity of the conductive connecting cylinders (1125), and each of the insulating nails (1127) is respectively inserted into a corresponding conductive connecting cylinder (1125).

7. The plasma cleaning head for an optical member according to claim 5, wherein the plasma circulation assembly (11) further comprises a high-frequency voltage conduction prevention subassembly (113) and a high-frequency navigation plug (114);
the high-frequency voltage conduction prevention subassembly (113) is inserted in the first groove, two ends of the high-frequency voltage conduction prevention subassembly (113) are respectively provided as a voltage output end and an access end, the voltage output end is embedded in the conductive clamping seat (1123), and the access end and the high-frequency navigation plug (114) are both located outside the first fixed frame (111); and
the high-frequency navigation plug (114) is respectively provided with a voltage input portion and a voltage transfer portion electrically connected to the voltage input portion, the voltage transfer portion is embedded in the access end, and the voltage transfer portion is electrically connected to the voltage output end.

8. The plasma cleaning head for an optical member according to claim 7, wherein the high-frequency voltage conduction prevention subassembly (113) comprises a first insulating sleeve (1131), a vacuum sealing ring (1132), a second insulating sleeve (1133), a conductive strut (1134), a nut (1135) and a protective sleeve (1136);
the first insulating sleeve (1131) is arranged opposite to the second insulating sleeve (1133) and has an accommodating space with the second insulating sleeve (1133), the vacuum sealing ring (1132) seals the accommodating space, and both the first insulating sleeve (1131) and the second insulating sleeve (1133) are embedded in the first groove bottom;
the conductive strut (1134) is successively inserted into the first insulating sleeve (1131), the vacuum scaling ring (1132) and the second insulating sleeve (1133), and conductive strut (1134) is provided with the voltage output end extending outside the first insulating sleeve (1131);
the nut (1135) is embedded in the protective sleeve (1136), the protective sleeve (1136) is nested outside the second insulating sleeve (1133), the protective sleeve (1136) is located outside the first fixed frame (111), and the protective sleeve (1136) is provided with the access end; and
the voltage transfer portion is in contact with the conductive strut (1134) through the nut (1135).

9. The plasma cleaning head for an optical member according to claim 2, wherein
the plasma cleaning head for an optical member further comprises a clip assembly (13) having a hollow shape; and
the clip assembly (13) is mounted on the lens frame (12), and the clip assembly (13) is nested at a periphery of the optical lens body (2), a gap is left between the optical lens body (2) and the lens frame (12), and the clip assembly (13) is adapted to seal the gap.

10. The plasma cleaning head for an optical member according to claim 9, wherein the clip assembly (13) comprises a second fixed frame (131) and a flexible gasket (132) mounted on the second fixed frame (131); and
the second fixed frame (131) is detachably butted to the lens frame (12), and the flexible gasket (132) surrounds among the second fixed frame (131), the lens frame (12) and the optical lens body (2), and the flexible gasket (132) is adapted to seal the gap.

11. The plasma cleaning head for an optical member according to claim 10, wherein the flexible gasket (132) is detachably mounted on the second fixed frame (131).

12. A plasma cleaning device comprising the plasma cleaning head for an optical member according to claim 1.

13. The plasma cleaning head for an optical member according to claim 3, wherein the plasma cleaning head for an optical member further comprises a clip assembly (13) having a hollow shape; and
the clip assembly (13) is mounted on the lens frame (12), and the clip assembly (13) is nested at a periphery of the optical lens body (2), a gap is left between the optical lens body (2) and the lens frame (12), and the clip assembly (13) is adapted to seal the gap.

14. The plasma cleaning head for an optical member according to claim 4, wherein the plasma cleaning head for an optical member further comprises a clip assembly (13) having a hollow shape; and
the clip assembly (13) is mounted on the lens frame (12), and the clip assembly (13) is nested at a periphery of the optical lens body (2), a gap is left between the optical lens body (2) and the lens frame (12), and the clip assembly (13) is adapted to seal the gap.

15. The plasma cleaning head for an optical member according to claim 5, wherein the plasma cleaning head for an optical member further comprises a clip assembly (13) having a hollow shape; and
the clip assembly (13) is mounted on the lens frame (12), and the clip assembly (13) is nested at a periphery of the optical lens body (2), a gap is left between the optical lens body (2) and the lens frame (12), and the clip assembly (13) is adapted to seal the gap.

16. The plasma cleaning head for an optical member according to claim 6, wherein the plasma cleaning head for an optical member further comprises a clip assembly (13) having a hollow shape; and
the clip assembly (13) is mounted on the lens frame (12), and the clip assembly (13) is nested at a periphery of the optical lens body (2), a gap is left between the optical lens body (2) and the lens frame (12), and the clip assembly (13) is adapted to seal the gap.

17. The plasma cleaning head for an optical member according to claim 7, wherein the plasma cleaning head for an optical member further comprises a clip assembly (13) having a hollow shape; and
the clip assembly (13) is mounted on the lens frame (12), and the clip assembly (13) is nested at a periphery of the optical lens body (2), a gap is left between the optical lens body (2) and the lens frame (12), and the clip assembly (13) is adapted to seal the gap.

18. The plasma cleaning head for an optical member according to claim 8, wherein the plasma cleaning head for an optical member further comprises a clip assembly (13) having a hollow shape; and
the clip assembly (13) is mounted on the lens frame (12), and the clip assembly (13) is nested at a periphery of the optical lens body (2), a gap is left between the optical lens body (2) and the lens frame (12), and the clip assembly (13) is adapted to seal the gap.

19. The plasma cleaning device of claim 12, wherein the plasma circulation assembly (11) comprises a first fixed frame (111) and a dielectric barrier-free electrode subassembly (112) embedded in the first fixed frame (111);
the first fixed frame (111) is provided with the outlet port (1111), and the outlet port (1111) is located at one side of the dielectric barrier-free electrode subassembly (112); and
the lens frame (12) is detachably butted to the first fixed frame (111), a lens surface to be cleaned is provided on the optical lens body (2), and the lens surface to be cleaned is arranged parallel to and opposite to a plane where the outlet port (1111) is located.

20. The plasma cleaning device of claim 19, wherein a first groove is further provided on the first fixed frame (111), a notch of the first groove is provided as a first notch communicating with the outlet port (1111), the first notch is distributed inside the first fixed frame (111), and the dielectric barrier-free electrode subassembly (112) is detachably mounted in the first groove.
